(19) United States
(12) Patent Application Publication
(10) Pub. No.: US 2011/0040660 A1
(43) Pub. Date: Feb. 17, 2011

(54) Monitoring And Management Of Lost Product

(76) Inventors: Damon R. Allison, Maple Grove, MN (US); Justin L. Grammens, Saint Paul, MN (US); Samuel J. Schroeder, Minneapolis, MN (US); Jeffrey J. Sholl, Jackson, WY (US); John E. Haaland, Saint Paul, MN (US); Susan K. Harlander, Jackson, WY (US)

Correspondence Address: MCHALE & SLAVIN, P.A., 2855 PGA BLVD, PALM BEACH GARDENS, FL, 33410, US

(21) Appl. No.: 12/854,012

(22) Filed: Aug. 10, 2010

Related U.S. Application Data
(60) Provisional application No. 61/232,515, filed on Aug. 10, 2009.

(51) Int. Cl. G06Q 10/00; G06F 3/048; G06F 15/16

(52) U.S. Cl. 705/28; 705/317; 705/1.1; 715/751

(57) ABSTRACT

A waste monitoring system includes a portable device to monitor product wastage. The portable device includes a processor and a memory in communication with the processor. The memory stores processor-executable instructions that, when executed by the processor, cause the processor to control operation of the portable device to generate a graphical user interface (GUI) to collect quantity data relating to respective quantities of a plurality of types of wasted products, and to calculate cost data as a function of the quantity data. A display device displays the GUI. A server is in communication with the portable device and is configured to receive the quantity data and the cost data from the portable device. A computing device is in communication with server and is configured to receive the quantity data and the cost data from the server and to display at least one of the quantity data and the cost data.

### CROSS-REFERENCE TO RELATED APPLICATIONS

This application is related by subject matter to U.S. Patent Application Ser. No. ______, filed on Aug. 10, 2010, entitled “SYSTEM AND METHOD OF PROVIDING PRODUCT QUALITY AND SAFETY,” which is a continuation in part of U.S. patent application Ser. No. 12/429,251, filed on Apr. 24, 2009, entitled “SYSTEM AND METHOD OF PROVIDING PRODUCT QUALITY AND SAFETY”. This application claims the benefit under 35 U.S.C. 119(e) of U.S. Provisional Patent Application Ser. No. 61/232,515, filed on Aug. 10, 2009 entitled “MONITORING AND MANAGEMENT OF LOST PRODUCT. All the applications are incorporated herein by reference in their entirety.

### FIELD OF THE DISCLOSURE

The disclosure relates generally to managing inventories of perishable goods. More particularly, the disclosure relates to monitoring and managing waste of perishable goods.

### BACKGROUND

Companies are concerned with the negative impact of products that do not meet their critical quality and food safety standards. Production, processing, and finished food preparation systems that are designed to assure compliance can also increase operational productivity. However, such systems also utilize human oversight, and safe food products require vigilance and a great deal of knowledge and experience with respect to food handling.

In general, food monitoring usually involves experts from various fields, including scientific, engineering, and information system disciplines. In particular, food monitoring typically involves microbiologists, chemists, food technologists, human resource professionals, computer specialists, engineering staff, training staff, legal experts, government experts, or any combination thereof. Further, consulting companies, auditors, testing laboratories, and information technology companies may be included in the food monitoring process. However, such experts can make a difference in food safety at a particular location only when the workers at the particular location apply the knowledge to the work of producing, processing, cooking, and serving the customers that consume the food products and the management in charge has systems for monitoring such critical activities.

About 35 years ago, safe food became a cross-disciplinary challenge when the Pillsbury Company, under contract to the National Aeronautics and Space Administration (NASA), had to provide safe food for astronauts during missions. The Pillsbury Company identified critical risks in the process of producing the finished products, resulting in an analysis of potential hazards and the critical controls needed to eliminate or reduce the potential hazards. The resulting preventive approach became known as the Hazard Analysis and Critical Control Point (HACCP) system, which has become an international standard that is accepted by both businesses and governments. The HACCP system, which has been adopted by the National Restaurant Association, is generally regarded as the best overall approach to preventing food borne illness by actively controlling hazards throughout the food production process.

However, for the HACCP system to work, it is necessary for the food workers, the inspectors, and everyone involved in the food distribution process to know the hazards and to know the actions necessary to manage the critical control points. Critical control points can represent the place and time in a process where actions are needed to complete critical tasks. Critical tasks can be those actions required to achieve the most effective desired outcomes when performed at a critical control point. Further, the person who knows the hazards and the necessary actions should have the authority to make the necessary decisions to ensure the effectiveness of the control points. That authority includes the decision to take corrective action or to stop a process impacted by a control point failure until a proper assessment and corrective action are undertaken. The person having such authority is a “bell-ringer,” which is a person who is part of a trusted team whose action occurs before the “problem” occurs (before the problem impacts a consumer), as opposed to a “whistle-blower” whose action takes place after the “problem” occurs (after the problem impacts a consumer).

One component of the HACCP system involves discarding food products that fail quality control measures. In addition, food products may also be wasted for other reasons, such as employee theft. In the food service industry, restaurant owners are looking for ways to monitor and manage their overall “shrink,” which refers to the quantity of food products that are lost or discarded due to, for example, employee theft, quality (e.g., expiration), or mistakes in the creation of food items being served to their customers. Restaurant and other food manufacturing operations can throw away thousands of dollars worth of food each month. In view of this waste, tracking and managing their food inventory relative to items wasted can represent expenses that owners may be able to save and invest in other ways for their business.

### SUMMARY OF THE DISCLOSURE

According to various example embodiments, a waste monitoring system facilitates managing costs incurred due to food or other products lost due to waste. The waste monitoring system uses a portable device and web-based tools to provide real-time tracking and assessment of waste.

One embodiment is directed to a waste monitoring system comprising a portable device to monitor product wastage. The portable device includes a processor and a memory in communication with the processor. The memory stores processor-executable instructions that, when executed by the processor, cause the processor to control operation of the portable device to generate a graphical user interface (GUI) to collect quantity data relating to respective quantities of a plurality of types of wasted products, the GUI comprising a plurality of user-selectable elements accessible by a user, and to calculate cost data as a function of the quantity data. The portable device also includes a display device in communication with the processor and configured to display the GUI. The waste monitoring system also includes a server in communication with the portable device and configured to receive the quantity data and the cost data from the portable device. A computing device is in communication with server and is configured to receive the quantity data and the cost data from the server and to display at least one of the quantity data and the cost data.

In another embodiment, a portable device to monitor product wastage includes a processor and a memory in communication with the processor. The memory stores processor-executable instructions that, when executed by the processor, cause the processor to control operation of the portable device to generate a GUI to collect quantity data relating to respective quantities of a plurality of types of wasted products, the GUI comprising a plurality of user-selectable elements accessible by a user, calculate cost data as a function of the quantity data, and transmit the quantity data and the cost data to a server. A display device is in communication with the processor and is configured to display the GUI.

Yet another embodiment is directed to a method of monitoring product wastage. The method involves collecting quantity data relating to respective quantities of a plurality of types of wasted products. Cost data is calculated as a function of the quantity data. The quantity data and the cost data are transmitted to a server.

The present invention also involves the provision of a method of monitoring waste in a food or drug handling facility. The method includes providing an inspector with a first device operable to communicate with a remote computer. The first device is provided with first information communicable to an inspector in at least one of visual and audio form. The first information includes items to be inspected by said inspector. The inspector conducts an inspection at least in part pursuant to said first information. Second information is input into the first device representing results of the inspection. At least some of the second information is transmitted to remote computer to record a history of at least part of the inspection. The input second information is identified at least by date. The input second information is analyzed and a knowledge database usable to evaluate said inspection results and identifying waste is built. At least one of information and inspection instructions is sent to said first device for communication to said inspector if additional inspection work is desirable.

Various embodiments may provide certain advantages. For instance, by using the portable device and web-based tools described in this disclosure, a user can monitor quantities and costs of food products that are wasted based on a number of metrics, e.g., over various periods of time, for individual or aggregated categories of food products, and at various locations. These costs can be tracked in real time and over periods of time relative to goals set for food waste costs.

### BRIEF DESCRIPTION OF THE DRAWINGS

FIG. 1 is a flow diagram illustrating an example method for collecting waste data according to one embodiment;

FIG. 2 is a diagram illustrating an example waste monitoring system according to another embodiment;

FIG. 3 is a block diagram illustrating a portable device according to still another embodiment;

FIG. 4 is a diagram illustrating a graphical user interface (GUI) for managing a product;

FIG. 5 is a diagram illustrating a GUI for managing a waste goal;

FIG. 6 is a diagram illustrating a GUI displayed by the portable device of FIGS. 2 and 3 for accessing the portable device;

FIG. 7 is a diagram illustrating a GUI displayed by the portable device of FIGS. 2 and 3 for selecting a category of waste product;

FIG. 8 is a diagram illustrating a GUI displayed by the portable device of FIGS. 2 and 3 for selecting amounts of waste counted for a variety of products within a category of waste product;

FIG. 9 is a diagram illustrating a GUI displayed by the portable device of FIGS. 2 and 3 for selecting a category of waste product and displaying quantity data and cost data;

FIG. 10 is a diagram illustrating a GUI displayed by the portable device of FIGS. 2 and 3 for displaying a response status of a server after transmitting quantity data and cost data from the portable device to the server;

FIG. 11 is a flow diagram illustrating an example method for presenting collected waste data according to another embodiment;

FIG. 12 is a diagram illustrating a GUI displayed by a computing device in communication with the server for accessing the computing device;

FIG. 13 is a diagram illustrating an example report displayed by a computing device in communication with the server;

FIG. 14 is a diagram illustrating another example report displayed by the computing device;

FIG. 15 is a diagram illustrating still another example report displayed by the computing device; and

FIG. 16 is a diagram illustrating yet another example report displayed by the computing device.

### DESCRIPTION OF VARIOUS EMBODIMENTS

According to various embodiments, a waste monitoring system facilitates managing costs incurred due to food or other products lost due to waste. The waste monitoring system uses a portable device and web-based tools to provide real-time tracking and assessment of waste.

The following description of various embodiments implemented in the context of food products is to be construed by way of illustration rather than limitation. This description is not intended to limit the scope of the disclosure or the applications or uses of the subject matter disclosed in this specification. For example, while various embodiments are described as being implemented in a food service environment, it will be appreciated that the principles of the disclosure are applicable to waste monitoring systems operable in other environments, such as pharmaceutical manufacturing facilities.

In the following description, numerous specific details are set forth in order to provide a thorough understanding of various embodiments. It will be apparent to one skilled in the art that some embodiments may be practiced without some or all of these specific details. In other instances, well known components and process steps have not been described in detail.

Various embodiments may be described in the general context of processor-executable instructions, such as program modules, being executed by a processor. Generally, program modules include routines, programs, objects, components, data structures, etc., that perform particular tasks or implement particular abstract data types. Certain embodiments may also be practiced in distributed processing environments in which tasks are performed by remote processing devices that are linked through a communications network or other data transmission medium. In a distributed processing environment, program modules and other data may be located in both local and remote storage media, including memory storage devices.

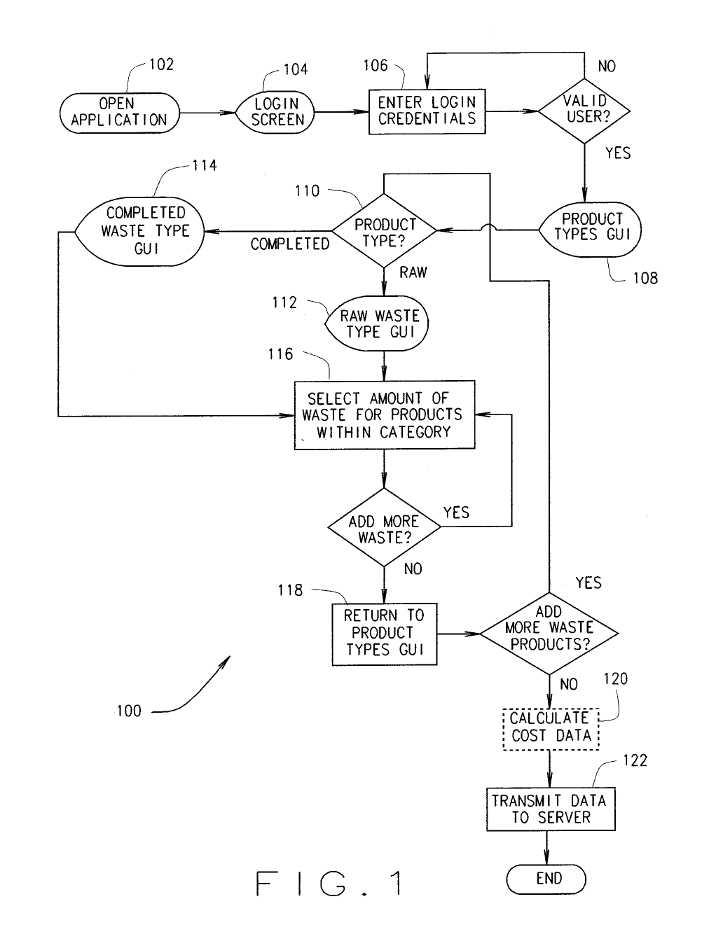

Referring now to the drawings, FIG. 1 is a flow diagram illustrating an example method 100 for collecting waste data according to one embodiment. First, at a step 102, a user opens an application on a portable device. At a step 104, the application presents the user with a login screen, at which the user may enter login credentials at a step 106. If the user enters invalid login credentials, the application returns to step 106, at which the user may attempt to reenter his or her login credentials. While not required, the application may lock out the user after a number of unsuccessful login attempts.

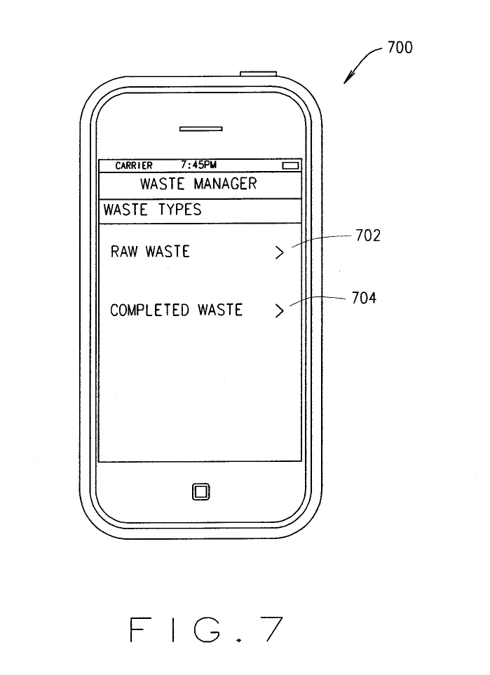

After the user enters valid login credentials, the application presents the user with a graphical user interface (GUI) for selecting a category of waste product at a step 108. FIG. 7 illustrates an example GUI for this purpose. At a step 110, the application uses the GUI to receive a user selection of a category of waste product for which the user wishes to enter amounts of waste counted for a variety of products within the selected category of waste product.

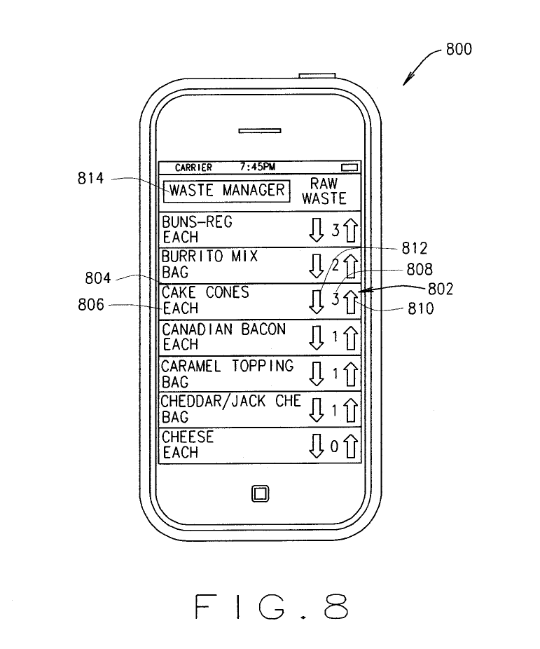

After the user selects a category of waste product, the application proceeds to one of a number of screens depending on the selected category. As shown in FIG. 1, if the user selects a “Raw Waste” category, the application presents the user with a GUI for entering amounts of waste counted for a variety of products within the Raw Waste category at a step 112. FIG. 8 illustrates an example GUI for entering amounts of waste counted for Raw Waste products. On the other hand, if the user selects a “Completed Waste” category at step 110, the application instead presents the user with a GUI for entering amounts of waste counted for a variety of products within the Completed Waste category at a step 114. Persons of skill in the art will appreciate that any number of categories of waste product may be defined, each of which causes the application to present the user with a GUI for entering amounts of waste counted for products within that category.

The application then proceeds to a step 116, at which the presented GUI is used to facilitate entry of amounts of waste counted for various products within the selected category. When the user has finished entering amounts of waste for the selected category, the user may select a “waste manager” button or similar control to cause the application to proceed to a step 118, at which the application returns to the GUI for receiving a user selection of a category of waste product, e.g., the GUI shown in FIG. 7. If the user wishes to enter data for more waste products, the application returns to step 110. On the other hand, if the user is ready to submit the quantity data to the server, the user may select an “Empty Bucket” button or a similar control, causing the application to proceed to a step 122, at which the quantity data is transmitted to the server. While not required, in some embodiments, the application may instead proceed to an optional step 120, at which the application calculates cost data as a function of the quantity data. In such embodiments, the cost data would also be transmitted to the server at step 122. Alternatively, the cost data can be calculated at the server or at another computing device that is in communication with the server.

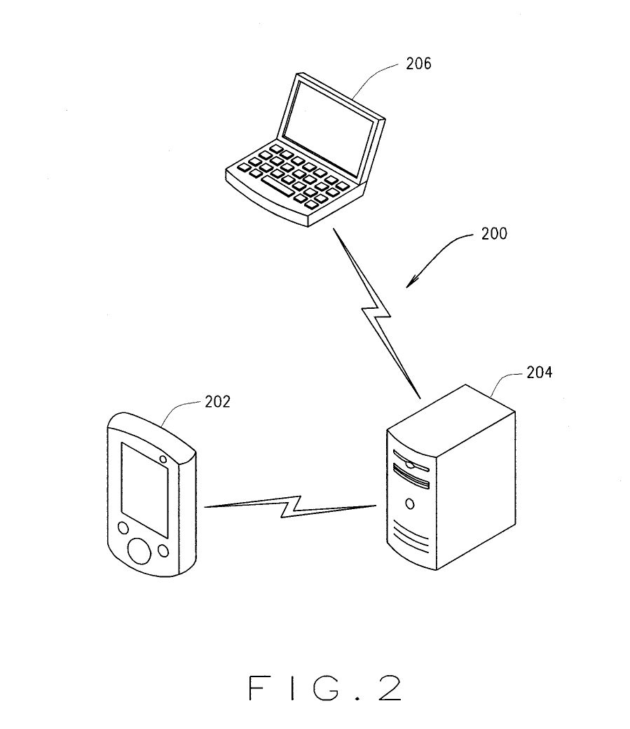

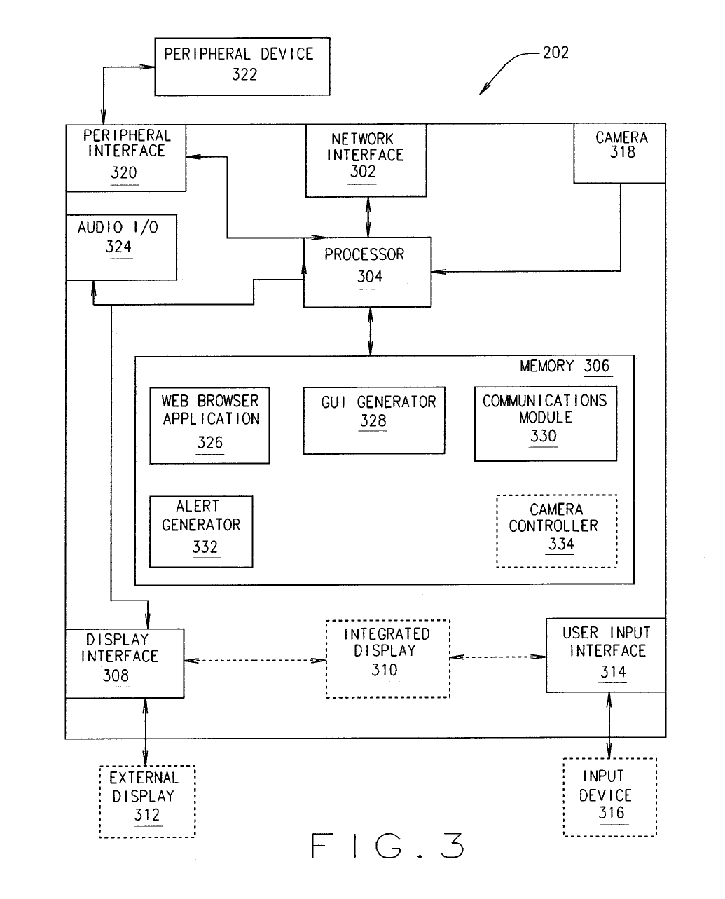

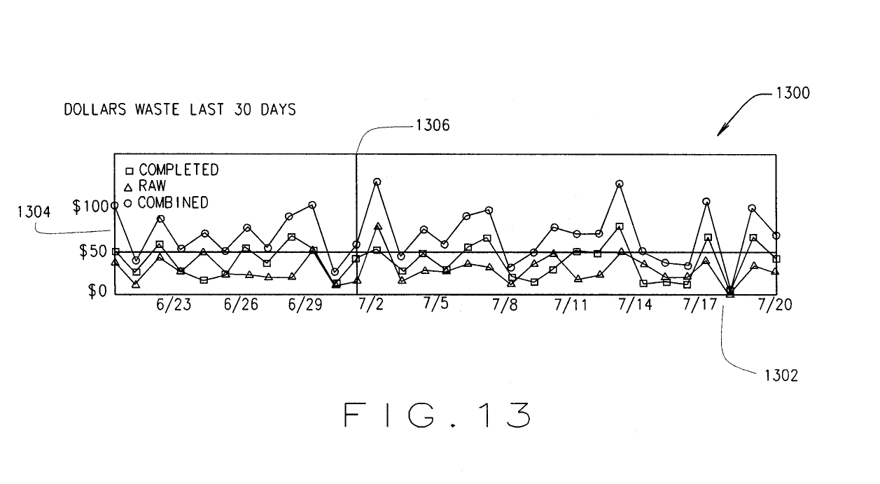

FIG. 2 is a diagram illustrating an example waste monitoring system 200 according to another embodiment. The waste monitoring system 200 includes a portable device 202, an example of which is shown in greater detail in FIG. 3. A server 204 is in communication with the portable device 202, for example, via a communication network such as the Internet. The server receives the quantity data and the cost data from the portable device 202 and may transmit product lists or other data to the portable device 202. A computing device 206 is in communication with the server 204 via a communication network, such as the Internet, and is configured to receive the quantity data and the cost data from the server and to display at least one of the quantity data and the cost data. FIGS. 13-16, described in greater detail below, illustrate a number of example reports that can be generated by the computing device 206. While the above discussion assumes that the portable device 202, the server 204, and the computing device 206 communicate with one another via the Internet, it will be appreciated that the portable device 202, the server 204, and the computing device 206 may communicate with one another using other types of networks, including local area networks, wide area networks, wireless networks, or any combination thereof.

The server 204 and the portable device 202 may be used in a variety of contexts, including service environments, processing environments, production environments, or any combination thereof. For the sake of clarity, this discussion uses a food service or food production environment as the particular implementation, but it should be understood that the portable device 202 and the server 204 can be adapted to provide waste monitoring for any number of facilities in almost any industry.

FIG. 3 is a block diagram illustrating an example implementation of the portable device 202. The portable device 202 may be implemented as any of a variety of devices, including, without limitation, laptop computers, handheld computers, web-enabled phones, personal digital assistants (PDAs), smartphones, and other computing devices. The portable device 202 can include a network interface 302 that is coupled to a network, such as the Internet, and that is adapted to communicate with the server 204 of FIG. 2 via the network. The portable device 202 can further include a processor 304 and a memory 306 that is accessible to the processor 304.

The processor 304 is typically configured to operate with one or more types of processor readable media. Processor readable media can be any available media that can be accessed by the processor 304 and includes both volatile and nonvolatile media, removable and non-removable media. By way of example, and not limitation, processor readable media may include storage media and communication media. Storage media includes both volatile and nonvolatile, removable and nonremovable media implemented in any method or technology for storage of information such as processor-readable instructions, data structures, program modules, or other data. Storage media includes, but is not limited to, RAM, ROM, EEPROM, flash memory or other memory technology, CD-ROM, digital versatile discs (DVDs) or other optical disc storage, magnetic cassettes, magnetic tape, magnetic disk storage or other magnetic storage devices, or any other medium that can be used to store the desired information and that can be accessed by the processor 304. Communication media typically embodies processor-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also intended to be included within the scope of processor-readable media.

The portable device 202 can further include a display interface 308 that is coupled to the processor 304 and that is adapted to display a graphical user interface. In a first embodiment, the display interface 308 can include an integrated display device 310 (such as a touch screen or liquid crystal display (LCD)). In another embodiment, the display interface 308 may be adapted to communicate with an external display device 312. 100431 The portable device 202 can also include a user input interface 314 that is coupled to the processor 304 and that is adapted to receive user input. In a first embodiment, the user input interface 314 can be associated with the integrated display device 310 (e.g., a touch screen) or can be integrated within the portable device 202. In an example, the user input interface 314 can include a keypad, a keyboard, a stylus, another input device, or any combination thereof. In another particular embodiment, the user input interface 314 can be coupled to an input device 316, such as a keyboard or another input device.

The portable device 202 may also include a camera 318 that is coupled to the processor 304 and that is adapted to capture a digital image. The portable device 202 may also include a peripheral interface 320 that is coupled to the processor 304 and that is adapted to communicate with one or more peripheral devices 322. In a particular embodiment, the one or more peripheral devices 322 may include a photoscopic device, a sensor, a contamination detection device, or any combination thereof. The portable device 202 can utilize the one or more peripheral devices 322 to detect a food event and to communicate data related to the food event to a food safety system via the portable device 202. Additionally, the portable device 202 can include an audio input/output (I/O) interface 324, which may include a speaker to output audio data and a microphone to receive audio input.

The memory 306 can include a web browser application 326 that is executable by the processor 304 to generate a web browser window for display at the display interface 308. The memory 306 can also include a graphical user interface (GUI) generator 328 that is executable by the processor 304 to generate a user interface including one or more user-selectable indicators, such as buttons, directed links, tabs, check boxes, text inputs, other interactive elements, or any combination thereof. The generated GUI may be provided to the display interface 308 within the web browser window provided by the web browser application 326.

The memory 306 can further include a communications module 330 that is executable by the processor 304 to facilitate communication between the portable device 202 and other devices in a variety of formats, including text, instant message, chat, Voice over Internet Protocol (VoIP), digital wireless formats, other formats, or any combination thereof In a particular embodiment, the digital wireless formats can include wireless telephone protocols or a short-range wireless protocol, such as an 802.11x communications protocol.

The memory 306 can also include an alert generator 332 that is executable by the processor 304 to generate an alert signal, such as an audible alarm, a visual alert, a text alert, a command, a tactile signal (e.g., vibration), another signal, or any combination thereof. In a particular example, the alert generator 332 can include digital signal processing features, including text-to-speech converters, to convert text into an audio alert signal. The alert signal may be communicated to the display interface 308, to the audio I/O interface 324, to a food safety system, or any combination thereof. The memory 306 can also include a camera controller 334 that is executable by the processor 304 to control the operation of the camera 318 to capture digital images in response to a user input.

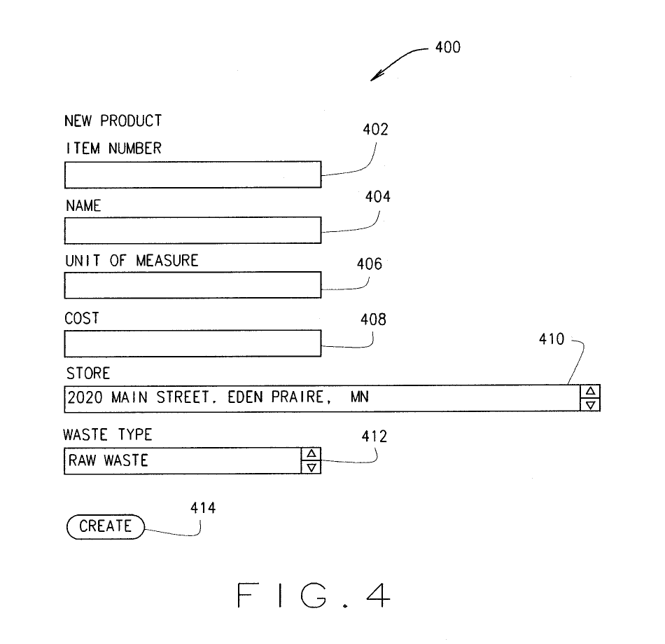

FIG. 4 is a diagram illustrating a graphical user interface (GUI) 400 for managing a product. The GUI 400 may be generated either on the portable device 202 or the computing device 206. The GUI 400 may be displayed, for example, when a manager or other administrator wishes to define a product type for monitoring waste. The GUI 400 includes a number of data entry fields. For example, an item number field 402 allows the administrator to enter an item number for the product. It will be appreciated that while the term “item number” is used in this example, the item number field 402 can be configured to accept either numeric or alphanumeric input. A name field 404 allows the administrator to enter a product name that food workers can use to identify the product easily when entering waste data. The GUI 400 also includes a units field 406 that allows the administrator to specify a unit of measure for counting wasted products. For example, hamburgers may be measured in sandwiches, while ground beef may be measured in pounds. In addition, a cost field 408 allows the administrator to specify the cost of the wasted product, for example, in terms of dollars for each unit of measure specified in the units field 406.

The GUI 400 may also include a number of drop-down menus. Unlike the data entry fields described above, the drop-down menus allow the administrator to select between a defined number of options. For example, a store drop-down menu 410 allows the administrator to select a store location for which the product definition specified by the other data entry fields is valid. In this way, the administrator can, for example, set different units of measure or different costs for like products at different store locations. A waste type drop-down menu 412 allows the administrator to assign a category to the product, such as “Raw Waste” or “Completed Waste.” The “Raw Waste” category may apply to ingredients, such as buns, hamburger patties, eggs, and the like. By comparison, the “Completed Waste” category may apply to completed food items, such as hamburgers, chicken sandwiches, etc. It will be appreciated that other categories of waste products can be defined in addition to these types.

The GUI 400 may also include a number of button controls. For example, the GUI 400 may include a “Create” button 414 that creates a product type as defined by the data entry fields and drop-down menus. Those of skill in the art will appreciate that the application may create the product type by creating a data structure or object having properties defined by the values entered in the data entry fields or selected using the drop-down menus. In addition, it will be appreciated that, while certain values are depicted and described as entered using data entry fields and other values are depicted and described as entered using drop-down menus, these examples are provided merely by way of illustration, and in many cases data entry fields and drop-down menus may be interchangeable. For example, while the units of measure are shown as being entered using the units field 406, a drop-down menu could be used instead.

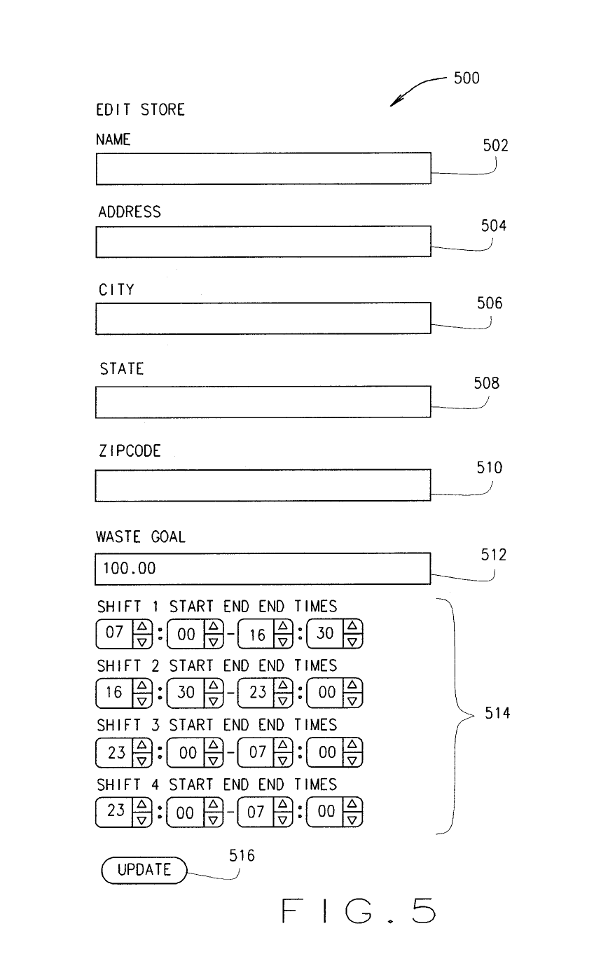

FIG. 5 is a diagram illustrating a GUI 500 for managing a waste goal. The GUI 500 may be generated either on the portable device 202 or the computing device 206. The GUI 500 may be displayed, for example, when a manager or other administrator wishes to define a store location or a waste goal for monitoring waste. The GUI 500 includes a number of data entry fields. A name field 502 allows the administrator to enter the name of a store location. An address field 504 allows the administrator to enter the store's address. A city field 506 allows the administrator to enter the city in which the store is located. Similarly, a state field 508 allows the administrator to enter the state in which the store is located. A ZIP code field 510 allows the administrator to enter the ZIP code of the store's location. It will be appreciated that some of the data entry fields may be omitted. For example, the city field 506 and the state field 508 can be omitted in some embodiments; in such embodiments, the application may determine the city and state based on the ZIP code entered in the ZIP code field 510. A waste goal field 512 allows the administrator to enter a waste goal for the store location. The waste goal may be expressed, for example, in terms of dollars per shift or dollars per day.

The GUI 500 may also include a number of drop-down menus. Unlike the data entry fields described above, the drop-down menus allow the administrator to select between a defined number of options. For example, shift time drop down menus 514 allow the administrator to define start and end times for a number of shifts. While four shifts are shown in FIG. 5, any number of shifts may be defined in this manner.

The GUI 500 may also include a number of button controls. For example, the GUI 500 may include a “Update” button 516 that updates or creates a store location as defined by the data entry fields and drop-down menus. Those of skill in the art will appreciate that the application may create the store location by creating a data structure or object having properties defined by the values entered in the data entry fields or selected using the drop-down menus. In addition, it will be appreciated that, while certain values are depicted and described as entered using data entry fields and other values are depicted and described as entered using drop-down menus, these examples are provided merely by way of illustration, and in many cases data entry fields and drop-down menus may be interchangeable. For example, while the shift start and end times are shown as being entered using the shift time drop-down menus 514, data entry fields could be used instead. Conversely, while the state is shown as being entered using the state field 508, a drop-down menu could be used instead.

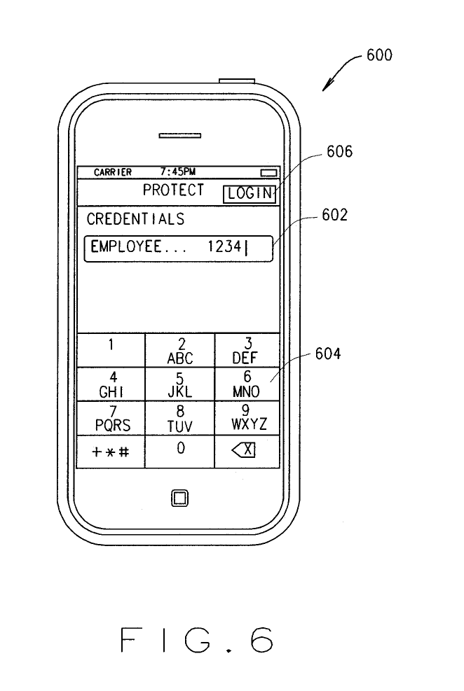

FIG. 6 is a diagram illustrating a GUI 600 displayed by the portable device 202 of FIGS. 2 and 3 for accessing the portable device 202. The portable device 202 may display the GUI 600, for example, when a user starts an application for entering waste data. The GUI 600 includes a numeric data entry field 602 for entering an identifier that identifies the user, such as an employee number. The GUI 600 also includes a numeric keypad 604 to allow the user to enter numbers into the numeric data entry field 602. A login button 606 is used to complete the login process.

It will be appreciated that some embodiments may present alternate implementations of the GUI 600. For example, while not shown, the GUI 600 may incorporate a password field for entering a password. Alternatively, the application may request the user's password after the login button 606 is selected. As another variation, in some embodiments, the identifier that identifies the user may contain alphanumeric characters. In such embodiments, the GUI 600 may present the user with a soft keyboard (not shown) for entering letters or may receive alphanumeric input via the numeric keypad 604, possibly using predictive text entry. In some embodiments, the portable device 202 may have a hardware implemented keyboard that can be revealed by, for example, sliding open the portable device 202.

FIG. 7 is a diagram illustrating a GUI 700 displayed by the portable device 202 of FIG. 3 for selecting a category of waste product. The portable device 202 may display the GUI 700, for example, after the user enters valid login credentials, as shown at step 108 of FIG. 1. The GUI 700 includes a number of user selectable elements 702 and 704, each of which corresponds to a category of waste product. As shown in FIG. 7, for example, the user selectable element 702 corresponds to the “Raw Waste” category, while the user selectable element 704 corresponds to the “Completed Waste” category. Selecting either user selectable element 702 or 704 causes the application to display a GUI allowing the user to enter amounts of wasted product within the corresponding category, as shown at steps 110, 112, and 114 of FIG. 1.

FIG. 8 is a diagram illustrating a GUI 800 displayed by the portable device 202 of FIG. 3 for selecting amounts of waste counted for a variety of products within a category of waste product. The portable device 202 may display the GUI 800, for example, after the user selects the user selectable element 702 of FIG. 7, as shown at step 112 of FIG. 1. The GUI 800 includes a number of rows, one for each product within the selected category. If the selected category has more products than can be displayed on the screen, the GUI 800 may display a partial list and may display additional rows in response to, for example, a swiping gesture performed on the screen. In some embodiments, the portable device 202 is equipped with a trackball or similar device that can be used to cause the list to scroll up or down.

The rows of the GUI 800 of FIG. 8 include similar elements, some of which are user selectable. For purposes of clarity, the elements of only one row 802 are specifically designated with reference numerals. It will be appreciated that the reference numerals that are used to designate the elements of the row 802 are intended to designate like elements in other rows generally. A product name field 804 displays the name of the product, e.g., “Cake Cones.” A units field 806 displays the units of measure applied to the product, e.g., “each.” A quantity field 808 displays the current count of wasted product of the type represented in the row 802. The user can adjust this count upward or downward using widgets 810 and 812, respectively. In some embodiments, the GUI 800 may allow the user to enter the count in other ways. For example, while not shown, the GUI 800 may allow the user to select the quantity field 808 and, in response to detecting selection of the quantity field 808, display a numeric keypad to allow the user to enter a count directly rather than having to increment to the correct count.

In addition to the list of products within the selected category, the GUI 800 of FIG. 8 also includes a “Waste Manager” button 814 that, when selected, causes the application to return to the GUI 700 of FIG. 7, as shown at step 118 of FIG. 1.

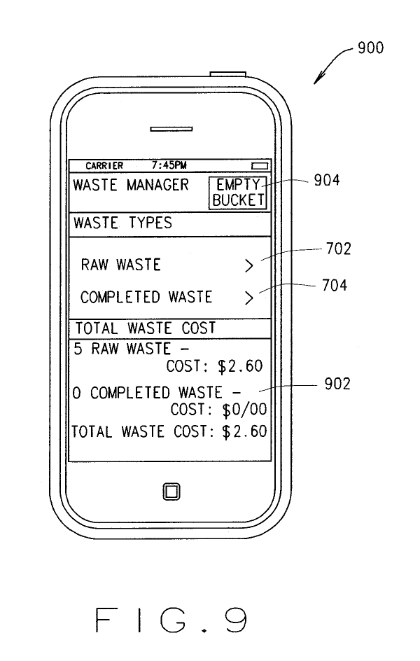

FIG. 9 is a diagram illustrating a GUI 900 displayed by the portable device 202 of FIG. 3 for selecting a category of waste product and displaying quantity data and cost data. The portable device 202 may display the GUI 900 after the user selects the “Waste Manager” button 814 of FIG. 8. The GUI 900, like the GUI 700 of FIG. 7, contains user selectable elements 702 and 704 for selecting the “Raw Waste” and “Completed Waste” categories of waste products, respectively. Selecting either of these user selectable elements will cause the application to display a GUI allowing the user to enter amounts of wasted product within the corresponding category, such as the GUI 800 of FIG. 8.

In addition to these elements, the GUI 900 also includes a cost display area 902 that displays quantity and cost data for each category of wasted product. As shown in FIG. 9, this data may be aggregated by category, as well as aggregated across categories. The cost data can be calculated either by the portable device 202, by the server 204, or by a computing device 206 in communication with the server 204. In the latter two cases, the cost data is downloaded to the portable device 202 and displayed with the quantity data. The GUI 900 also includes an “Empty Bucket” button 904 that, when selected, causes the application to transmit the quantity data and cost data to the server 204, as indicated at step 122 of FIG. 1.

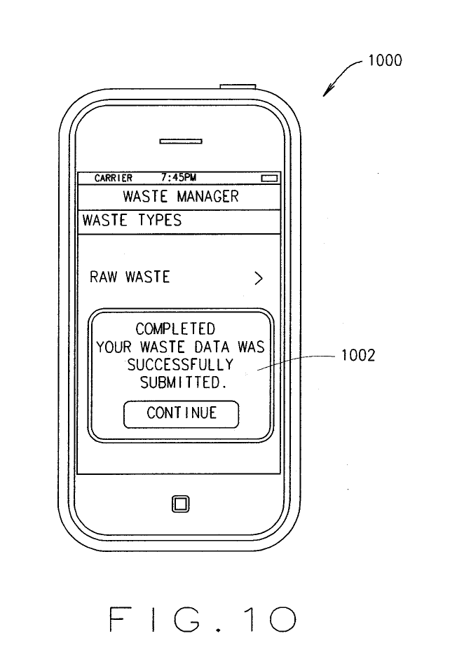

FIG. 10 is a diagram illustrating a GUI 1000 displayed by the portable device 202 of FIG. 3 for displaying a response status of the server 204 after transmitting quantity data and cost data from the portable device 202 to the server 204. The portable device 202 may display the GUI 1000 after the user has selected the “Empty Bucket” button 904 of the GUI 900 of FIG. 9. After the transmission of data to the server 204 has completed, a notification window 1002 may appear to alert the user that the data was successfully transmitted. In some embodiments, the GUI 1000 may also provide a visual indication of the progress of the transmission of data to the server 204, such as a progress bar. If the transmission was unsuccessful, the GUI 1000 may instead display an error message (not shown).

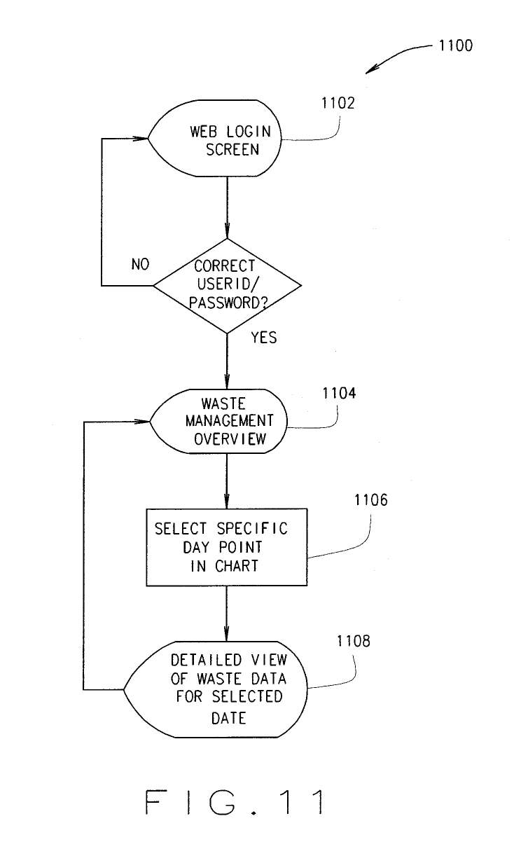

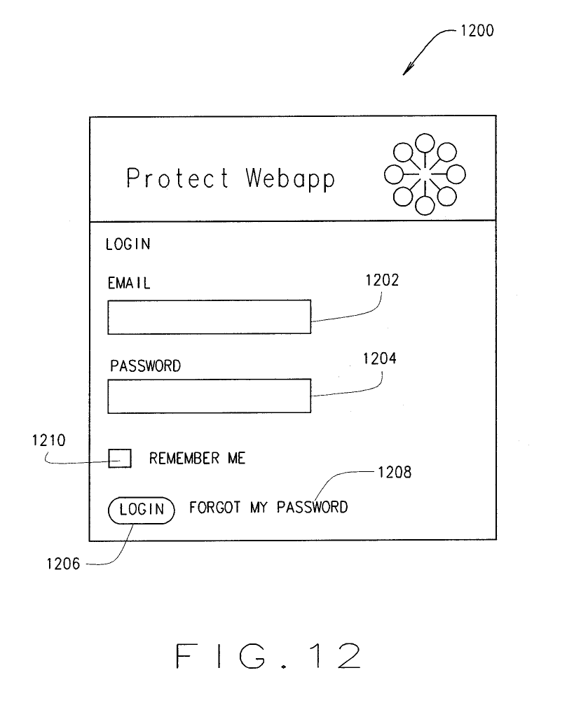

FIG. 11 is a flow diagram illustrating an example method 1100 for presenting collected waste data using a web-based application according to another embodiment. First, at a step 1102, the web-based application presents the user with a login screen, such as the GUI 1200 of FIG. 12, at which the user may enter login credentials. If the user enters invalid login credentials, the application returns to step 1102, at which the user may attempt to reenter his or her login credentials. While not required, the application may lock out the user after a number of unsuccessful login attempts.

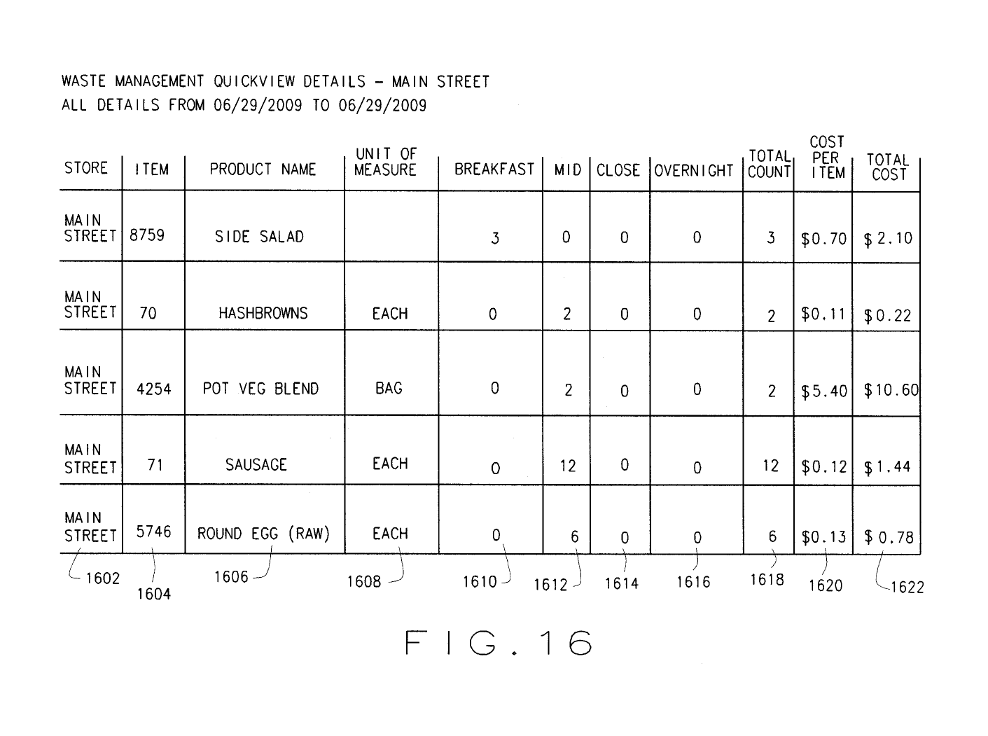

If the user successfully logs in, the web-based application proceeds to a step 1104, at which the web-based application displays a summary chart of the collected waste data, such as the report 1300 of FIG. 13, which is discussed in further detail below. Within the report 1300, the user may select a specific day illustrated within the chart at a step 1106. In response to receiving the user selection of a specific day, the web-based application proceeds to a step 1108, at which the web-based application generates a detailed view of the waste data for the selected day, such as the report 1600 of FIG. 16.

FIG. 12 is a diagram illustrating a GUI 1200 displayed by a computing device 206 in communication with the server 204 for accessing the computing device 206. The computing device 206 may display the GUI 1200, for example, when a user starts a web based application for viewing waste data. The GUI 1200 includes a data entry field 1202 for entering an identifier that identifies the user, such as an email address, username, or employee number. The GUI 1200 also includes a password entry field 1204 to allow the user to enter alphanumeric characters. A login button 1206 is used to complete the login process. A forgotten password link 1208 may be provided to either provide the user with a password hint or reset the user's password. A check box 1210, if selected, causes a browser executing on the computing device 206 to store a cookie on the computing device 206 so that the user will not have to enter his or her email address, username, or employee number during a subsequent login attempt.

After the user has completed the login process using the GUI 1210, FIG. 13 is a diagram illustrating an example report 1300 displayed by the computing device 206 after it has downloaded quantity data or cost data, or both, from the server 204. The report 1300 is displayed as a stacked line graph with dates along an x (horizontal) axis 1302 and waste along a y (vertical) axis 1304. In the example report 1300 of FIG. 13, waste is plotted as dollars. In other embodiments, however, waste could be plotted as units. For example, if the administrator wishes to see waste data for a particular product, it may be helpful to present the data in terms of quantities rather than costs.

For each day shown on the report 1300, waste data is displayed for both the Raw Waste and Completed Waste product categories. In addition, the report 1300 shows the total waste for each day, determined by summing the waste data for the Raw Waste and Completed Waste product categories for each day.

In some embodiments, the report 1300 is interactive with the user. For example, the web application may display the waste data associated with a particular data point 1306 when the user hovers over the data point with a cursor controlled by a pointing device, such as a mouse or touchpad. In addition, clicking on the data point 1306 may cause the web-based application to display a detailed view of the waste data for the day represented by the selected data point 1306. This detailed view may be presented, for example, using a report 1600 as illustrated in FIG. 16, discussed in further detail below.

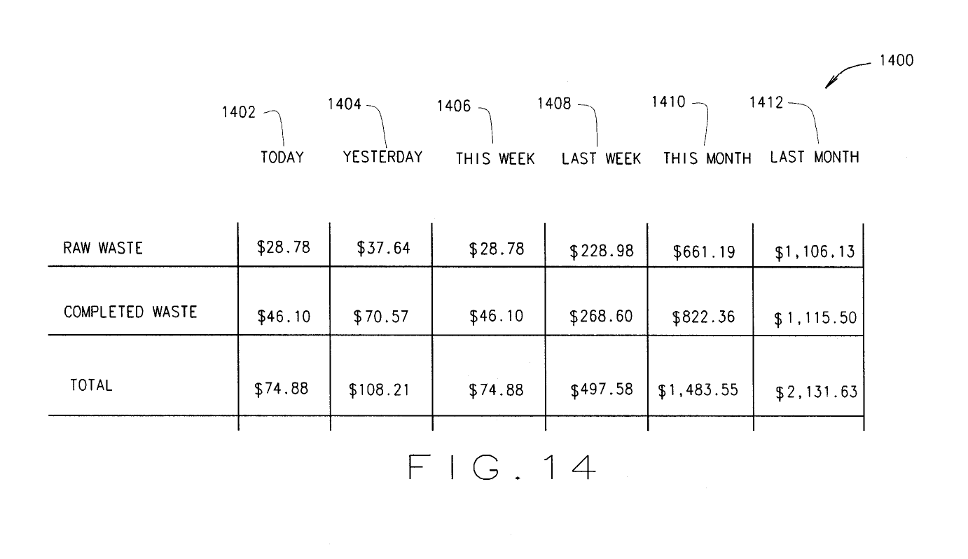

FIG. 14 is a diagram illustrating another example report 1400 displayed by the computing device 206. The web-based application may display the report 1400 in response to any of a variety of user actions, including, for example, right-clicking on the report 1300 of FIG. 13, selecting a particular report type from a menu, or using a keyboard shortcut. The report 1400 is presented as a table showing waste costs over a number of time periods. The waste costs are aggregated by category (Raw Waste and Completed Waste products) and across categories (Total).

For each category and across categories, the report 1400 displays waste costs for the current day in a column 1402. The previous day's data is displayed in a column 1404. A column 1406 displays waste cost data for the current week. Waste cost data for the previous week is displayed in a column 1408. A column 1410 displays waste cost data for the current month. The previous month's data is displayed in a column 1412.

The report 1400 may be interactive with the user. For instance, the web application may display a detailed view of the waste data associated with a particular time period when the user selects a cell in the table. As a particular example, clicking on a cell within the column 1402 may cause the web-based application to display a detailed view of the waste data for the current day, for example, using the report 1600 as illustrated in FIG. 16. Similarly, clicking on a cell within the column 1404 may cause the web-based application to display a similar view of the data for the previous day.

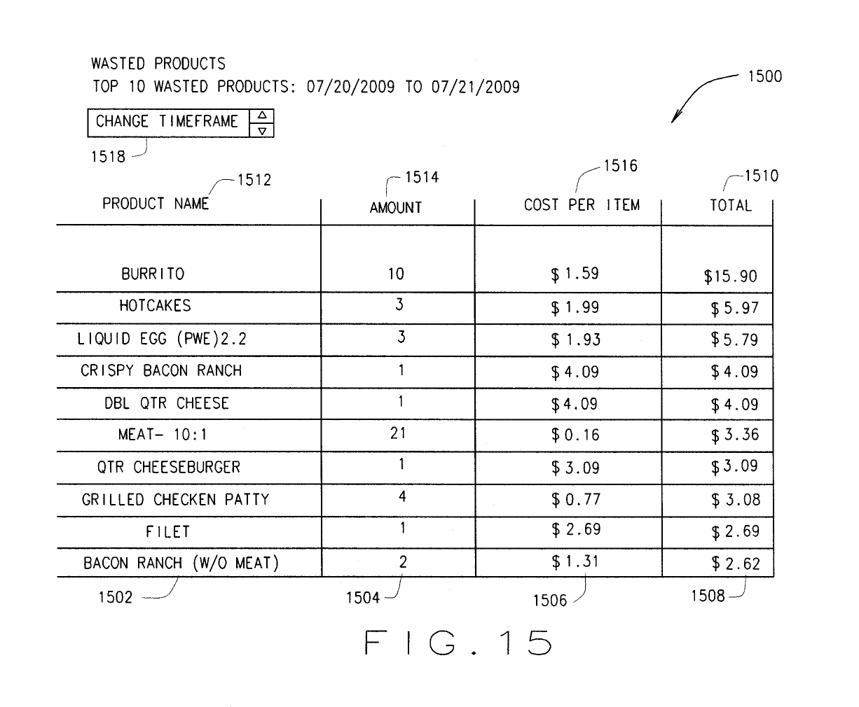

FIG. 15 is a diagram illustrating still another example report 1500 displayed by the computing device 206. The web-based application may display the report 1500 in response to any of a variety of user actions, including, for example, right-clicking on the report 1300 of FIG. 13, selecting a particular report type from a menu, or using a keyboard shortcut. The report 1500 displays a list of the products associated with the highest waste costs. The list may include the names of the products in a column 1502. A column 1504 displays the amount of wasted product for each listed product during a selected time period. The cost for each item is shown in a column 1506, and the total waste cost associated with the product type is displayed in a column 1508. The total waste cost is obtained by multiplying the values appearing in columns 1506 and 1508 for each product type.

In some embodiments, the report 1500 may be interactive with the user. For example, while the report 1500 is illustrated as being sorted from most wasted to least wasted over a period of two days, the user can change this view in a number of ways. In one embodiment, for instance, the web-based application may allow the user to reverse the sort order by clicking on a column header 1510 of column 1508. Further, the web-based application may allow the user to sort the products on other keys, such as the product name (in forward or reverse alphabetical order), amount, or cost per item by clicking on a column header 1512, 1514, or 1516. In addition, the web-based application may allow the user to change the time scale of the report 1500 by clicking on a widget 1518. Selecting the widget 1518 in this manner may cause a pull-down menu to appear to allow the user to select, for example, a different day, a week view, a month view, or a different time period.

FIG. 16 is a diagram illustrating yet another example report 1600 displayed by the computing device 206. The web application may cause the report 1600 to be displayed, for example, when the user selects a particular data point on the report 1300 of FIG. 13 or a cell in the report 1400 of FIG. 14. Alternatively, the web-based application may display the report 1600 in response to any of a variety of user actions, including, for example, right-clicking on the report 1300 of FIG. 13, selecting a particular report type from a menu, or using a keyboard shortcut.

The report 1600 displays a detailed view of both quantity data and cost data for wasted products for a particular store location and for individual product types. A column 1602 shows the store name. Columns 1604 and 1606 display the item number and product name, respectively, associated with each product type. A column 1608 displays the unit of measure assigned to each product type. Columns 1610, 1612, 1614, and 1616 display quantity data for wasted products of each product type for each shift in a day represented in the report 1600. The shift data shown in columns 1610, 1612, 1614, and 1616 are aggregated into a total daily count for each product type in a column 1618. A column 1620 displays the cost for each item, and the total daily waste cost associated with the product type is displayed in a column 1622. The total daily waste cost is obtained by multiplying the values appearing in columns 1618 and 1620 for each product type.

In some embodiments, the report 1600 may be interactive with the user. For example, the web-based application may allow the user to sort the products on other keys, such as the store location, item number, product name (in forward or reverse alphabetical order), amount, cost per item, or total cost by clicking on a column header.

It will be appreciated that the format of the report 1600 may be varied in a number of ways. For example, while the report 1600 is shown as displaying waste data for one store location, the report 1600 could show waste data for any number of store locations. In addition, certain columns may be omitted. For instance, if the administrator is only interested in viewing daily waste data, one or more of columns 1610, 1612, 1614, and 1616 may be omitted. As another example, if the report 1600 only contains waste data for one store, column 1602 may be omitted. The web-based application may allow the administrator to define which columns are included in a particular report.

Waste can include objects the holder discards, intends to discard, or is required to discard. Waste occurs in every food harvesting, preparation and processing activity. It is commonly known as “shrink”, the difference between what was intended to be used and that which actually is used. Often this is due to a failure of the ingredient or product to comply with standards or specifications (either based on quality or safety issues). But it can also be an inevitable by-product of the process, whereby cuttings of the plant or animal are not intended to be incorporated in the product. Waste always incurs a cost, so it is valuable to have the means to track it and manage it.

The present invention is better understood by a more detailed description of the method of monitoring waste in a government regulated facility wherein noncompliance with operating standards or government regulations, over production, bad scheduling, faulty usage projections, poor planning, poor handling, faulty order taking, faulty production, out of specification raw materials, faulty material handling or other unforeseen circumstances can be causes of the waste. Those facilities include food and drug handling facilities regulated by the FDA, EPA and/or USDA as well as state agencies or similar foreign government agencies authorized to regulate such facilities. In one embodiment, the facility is a food handling facility, which in the USA can be regulated by the FDA, USDA, EPA and state and local government entities. In addition to government regulation, the owner/manager of the plant or facility may also provide additional conditions and standards on the operation of the facility. In addition, strict liability or new laws impose regulations and actions on sources of supplies and buyers of materials provided to the facility that can also be better monitored with the present invention. The method will be described in the context of a food harvesting and/or handling facility like a restaurant, food service facility or a food manufacturing plant, but it is also applicable to drug (including pharmaceuticals, supplements and medical devices) handling and manufacturing facilities. Such facilities have a relatively large labor intensive workforce that portions of which have relatively short working tenure. The present invention provides a way to operate with less loss and improved continued consistency over time.

The following description uses the embodiment of the invention shown and described in FIGS. 2, 3 although it is applicable to other embodiments herein. A person or user (hereinafter referred to as inspector for convenience which can be any suitable person such as an employee, independent contractor or expert) is provided with a device 202 as described above and is trained to provide inputs to the device as described above. The inspector can be an employee (such as a quality assurance person or quality manager), a line employee (such as field worker, plant, kitchen, or assembly-line worker) or equipment operator in the facility, an independent contractor or someone working on behalf of a government entity. The device 202 may also provide the inspector with instructions as part of a standard inspection or task or in response to input from a manager or third party such as an independent expert. While in a facility, the inspector will select an application operable on the device 202, enter a location or facility code which will be time stamped to provide evidence of actual presence at a defined time. The inspector will preferably enter an ID code which can also automatically record the device ID and enter what task is being performed. It is to be understood that for single facility systems, that some of this information can be omitted. These inputs may also be verified by another person who can be on or off site like the facility manager or a remotely located manager or person. In a preferred embodiment, this data will be stored on the device 202, server 204 and/or the computer 206 or other components of a system such as the system 200. At least one of the components of the system 200 will provide security on this and other data inputs to provide evidence of task performance or inspection/monitoring in a manner that cannot be easily changed or forged, i.e., secured. Such data can be stored in a suitable memory of a component of the system 200 and secured as is known in the art. The device 202 can either travel with the inspector or be accessed by an inspector in a facility. For example, if the inspector enters a restaurant, the device 202 can be accessed by a login, identifying the inspector as being in that particular restaurant and provide a time stamp on the input to provide evidence of presence by the inspector. The device 202 can also be constructed and programmed to communicate with an RFID to establish its presence at a given facility or its location within a facility to accomplish a specific task. GPS could also be used to establish presence at a facility which could be used in combination with an identifier at the location like a scannable bar code unique to that facility. Other data inputs can also be time stamped and secured in the device 202 and/or in other parts of the system 200 such as the memory of the computer 206. The present invention is usable for scheduled and unscheduled normal audit inspections and can be used for daily routine operations and inspections.

In a preferred embodiment, the inspector can enter a product type and be prompted to enter data about the product or other information with the device 202 issuing instructions on what needs to be evaluated and what data to enter. Data requests can be communicated to the inspector by the device 202 (visually, photo or video and/or audio) and the inspector will provide the requested data, such as production quantities, inventory quantities, raw waste, completed waste, discards, cause of waste such as unsold, excess hold time, incorrect order entry, out of specification condition such as cooking device temperature, holding conditions such as food temperature and refrigerator temperature, proper source data on the food and food ingredients, cleanliness, proper handling instructions, proper worker attire, cleaning supplies, facility or shift startup, facility closing, ingredient and materials usage and disposal, sanitation and sanitation testing (e.g., pH and chlorine levels), spoilage, contamination, theft, etc. The device 202 can provide instructions on how certain inspection steps or tasks need to be conducted, for example, the device can provide an image to the inspector as to how and where to identify waste materials and the category it may apply to. This can be part of a regular step or task or one that one or more of the components of the system 200, in view of input data, determines should be done. An example of this can be due to statistical analysis of input data (created knowledge) that might indicate from other data or analysis that the process might be out of control. The data can include information about the facility and what happens in it, information about the materials provided to the facility and information about the finished product and its handling after preparation and after leaving the facility. The information provided to the system 200 can also include information about other safety, quality and regulatory schemes like environmental compliance, improper procedures, personnel, safety and the like that the inspection input data might trigger. An example of this might be apparent excess usage of an ingredient, product in-process, or improper disposal and accounting for material which can lead to waste. Bad safety practices and non-compliance with specifications can be major causes of waste.

The device 202 can also prompt the inspector to look for information outside of the normal. By way of example, if a possible problem has been identified with a particular source of an ingredient, like spoiled meat, the device will prompt the person to provide out of the normal inspection of the meat on premises, e.g., a particular batch or manufacturer. The proper receiving of goods and their quantities can be input, stored and analyzed. This can be used to identify problem suppliers. Another example may be potential equipment malfunctioning that can also prompt for additional inspection and data collection. This can be done with the present invention in real time, i.e., with less lag time that can occur with current information collection systems. The device can also prompt a person, prior to entering a facility, to take additional testing, sampling materials or equipment to address out of the normal issues. The system 200 can also request confirmation of receipt of instructions and if not confirmed, the system can prompt another person to personally communicate with the inspector to ensure the new instructions or tasks are addressed or be made aware of additional or changed tasks. The system 200 can also prompt an inspector that data needs to be taken at that time.

The system 200 provides for two way communication as described above. Data, instructions, instructional (e.g., training) material, alerts, changes, additions and updates can be provided in real time, relatively instantaneously and securely. The system can provide for real time notification of potential serious problems. This information can then be communicated through a common server to multiple inspection sites (inspectors) and through multiple companies when the system 200 is maintained by a third party. For example, an inspector working for company X identifies raw or completed product waste at a restaurant. The inspector can obtain the identifying information on those amounts and input that information into the device 202 with an alert and communicate that information to other components of the system 200 which in turn can notify inspectors and/or employees for company (or franchise) Y of the problem with an alert since in this case the interests of the competitors are the same, controlling and reducing waste. Management or government officials could also be similarly notified as well as the manufacturer of the suspected product in accordance with system programming. The system can also alert a person operating the system 200 of a potential problem who can intervene, provide analysis and judgment, and provide input to the system, and have the system alert or not alert inspectors as the intervention analysis dictates. The system 200 can also be used to provide appropriate notice to management and/or government agencies or flag to the inspector, facility management or system operator that a notice is or may be needed, and be used to help trace problem sources and commonality to multiple facilities. It may also inform company management that a notification to a government agency is needed or desired. Notices can be provided automatically pursuant to programmed instructions or by human intervention.

The inspector can follow a list provided on the device 202 for items to be inspected or acted on (including observed), for example counted or inventoried, including special instructions in the event emphasis needs placed on one or more items or in the event instructions have been temporarily or permanently changed or the data input from the current inspection indicates from the created knowledge base in the system indicates additional work needs to be done. The list can be contained in whole or in part in the device 202 or can be provided from other parts of the system 200 such as a computer 206 comprising at least part of the system 200. This can now be done in real time and help prevent follow up inspections or actions which are costly in time and perhaps even liability. Response time to standards not being met, either in quality, productivity or safety and potentially waste creating situations can be reduced. How to conduct the testing or inspection can be provided to an inspector as well. The sequence of inspection (including testing) can be provided to the inspector through the device 202. A prompt can be provided to the inspector to photograph a certain item. The inspector will conduct the inspection of the various indicated items and enter the results of the inspection which results may, when input and analyzed, result in instructions being provided to the inspector by the device in any suitable format (visual, photo or video and/or verbal, audio) for additional inspection. These instructions can be contained in the device 202 or provided to the device by other components of the system 200. The items indicated for inspection can be provided with an indication of importance or priority as well as sequence. Some instructions may be provided as prompts for lower priority items and some by flags for higher priority items. The instructions can be provided directly from an internal memory in the device 202 and/or from other memory devices in the system 200. The device 202 will have a processor (CPU) and a memory as is known in the art.

The inspector signs into the device 202 in the facility manually or automatically, or through a manager with security such as with a name and password, obtains the instructions and begins the evaluation of the facility and his assigned functions per the obtained instructions regarding tasks to be done and if needed, how to perform the tasks. The instructions can be custom made for the facility including instructions common to other similar facilities and those unique for the facility in question being inspected. The instructions can be stored in the device and/or can be provided in whole or in part from other parts of the system 200. If the facility has had certain problems in the past, the device 202 can provide the inspector additional instructions to follow up on the past problems to see if additional steps need to be taken or if remediation had been undertaken in the past. The inspector performs the instructed tasks and enters the requested data which shows the inspection and/or recommended work has been performed. Each of the individual inspection steps or selected task steps can be time stamped as performed and the sign in will indicate the facility or even a location in the facility which data can be associated with the inspection stamps. The data as entered can be secured against changing or will indicate if a change is made, for example if an entry is made in error, the system will indicate the change. The inspector can be provided with a prompt to provide a reason for the change. Areas in a facility may be provided with a readable supplemental location identifier (such as a readable RFID) if desired to indicate, when read by the device 202, the location of the inspector and the time of reading.

At the completion of the inspection or task completion a sign out procedure can be input into the device 202 and to the system 200 for storage. If desired, the sign out procedure can be the same as or similar to the initial sign in procedure. A sign in procedure may be associated with starting a shift or opening a facility and properly setting it up for its functions. A sign out procedure may be specific to ending a shift or locking down a facility, with all the tasks associated with these functions. An additional verification procedure like the sign in or sign out procedure can also be input at any desired step in the inspection. Collected data can be communicated to one or more of the other components of the system 200 when gathered or at any time during or after inspection completion as desired.

The system 200 is structured to receive data and other information from one or more devices 202 or other input sources either at the facility or remotely located. The system 200 is programmed at the computer 206 and/or at the device(s) 202 etc. to convert the input information and data into human usable knowledge to guide inspection and employee activities, management activities and activities of the person or people operating the system 200. Another way of stating it is that knowledge can be the practical use of data. Accurate data is a foundation upon which knowledge (useful information) is built, and actions based on knowledge lead to a desired outcome. The system receives various inputs of data, as discussed herein. Some of the input data or information is compiled and can be stored on any appropriate component of the system 200 like the computer 206. The programming for the system 200 is such as to create relations between the inspector input and the stored knowledge and history. Policies or error conditions can be created that permit evaluation of an inspector input including the knowledge and history to determine one or more communications of information back to the inspector for possible additional actions or tasks or to identify a possible problem.

The knowledge created can be raw data that is organized or sorted through for importance, new information that is generated by analysis such as statistical analysis or similar data combined from multiple inspections. It may also be created by human analysis and can include raw data that is put into a relationship to other data, e.g. raw waste loss per shift or total costs per shift, day, week or month. The generated knowledge base can be vertically integrated and horizontally integrated from various inputs. The data can be provided from multiple facilities/sites within a company, from multiple companies and from different industries. By way of example, data and information can be provided from multiple restaurants in the same company or two different restaurant chains and combined. The manipulation of a larger database can help an industry become smarter about what they are doing since they share, at least in large part a common interest in how a restaurant is operated, particularly safety issues that can create waste. Operating specifications can also be input, along with government regulations to build a knowledge base from the inputs. Supplier and customer data and specifications can also be input to assist in building a knowledge base. The knowledge can be used to guide human activity with and without human intervention with an inspector, company management and/or third party experts. This knowledge can also be translated into clear action items on a device 202 such that performance at an employee position can be assured, even in the occasion of employee or worker turn-over.

The input data can include authority levels and contact priority. By way of example, for certain discovered potential problems, only the inspector need be notified which can be done in real time and can include instructions for additional or further inspection/evaluation. For other issues, higher level management may be notified and in real time. For some issues, a user may also wish to or be required to notify the government and the system can send instructions back to the inspector to effect notification, deny the inspector the authorization and/or require additional inspection to ensure no errors have been made before such notification. The device 202 can also be provided with information for dissemination to the inspector as to who to notify and when, again, in real time to help reduce the risk of a crisis in the event a safety issue may be present.

The input data can also include sales data and incoming inventory data. In the case of a restaurant, the sales of each type of food can be captured at the checkout/order taking machine and then reconciled to obtain a gross indication of waste. But, it does not provide output indicating the reason for the waste. The input data from the system can be reconciled with this sales and inventory data to provide a much better analysis of the facility operation and provide usable knowledge to help reduce waste and to better compare to operations at other facilities. The knowledge generated or provided by the system 200 can be used to change behavior to improve waste performance. Such analysis and reconciliation can provide a much better understanding of waste causation and remedies. This system provides context to data, and other inputs. By way of example, restaurants currently inventory waste, but it is poorly done if at all, is not timely done in many cases, is inaccurately input into computers which makes the current process ineffective as a management tool. The present invention can solve those problems. It can force or incent through measurable productivity, behavioral compliance on workers and management including owners, for example waste inventory, production scheduling and the like. A device 202 can be used for an extended period of time without communicating with other components of the system 200 and can be programmed to accomplish any desired function, even functions done by other components of the system 200 depending on need and security. Data can be exchanged or transferred at any suitable time between the various components of the system 200.

The output from another part of the system 200 to the device 202 can also include responses to queries from the device 202 or other parts of the system 200. The queries can be generated by the device 202 automatically, or by the inspector. The response can be a standard response or can be a judgment response. The judgment response can be provided from human intervention through the system 200. By way of example, the inspector can input an acceptable goal for waste and the device 202 can inform the inspector that the waste incurred exceeds that goal resulting in new information for managing throughput in the next working period. Human judgment from either management or a person operating the system or on call through the system can answer the question even though the device 202 will indicate an out of specification condition. The human intervention can also indicate that even though there is an out of specification condition, that the operating conditions for a specific flow of products was at fault, allowing management to make changes to the operating conditions or product flow and thereby better manage waste under changing work conditions. This can be overlaid with an operating history of a particular machine or monitoring device to help effect a judgment. The input data can also include cost data which can be combined with waste data to create value of losses information which can be tracked over time and compared to other operating criteria, like shift, time of day, supplier, employees and operating specifications. Food inventory can be tracked and compared to waste and such other criteria. The activities that can be performed by the system 200 can be used to reduce waste and improve operational and economic efficiency.

The knowledge, stored data, information and the programming of the components of the system 200 can also be used to provide flag notices (structured priority notice) to an inspector, management, other companies and other industries as desired. The input data, the histories and knowledge can be used to track waste and to create information that can be communicated to an inspector on what actions or tasks can be done to perform further evaluations or remedial actions. A flag notice would be structured for more important issues needing higher management input/decision making, or third party input/decision. An example of such an issue is an outside inspector or manager has arrived to conduct an inspection showing that there have been several consecutive discard readings below the mean for coring heads of lettuce, which from the knowledge in the system 200 might indicate an out of control process from statistical process control analysis. Flags are used to indicate a level of importance. Different types of flags can be provided, including a critical flag that might indicate something like failure of a piece of equipment.

From the knowledge created by the system 200, information can be sent to one or more inspectors, one or more companies through their management and one or more industries. The returned information can include general instructions, action steps and other types of information. The knowledge can be generated by statistical analysis of the data from inspectors, employees, shifts, suppliers, specifications and operating standards, laws, including regulations and experience based knowledge of people. The system can be used to provide statistical process control information as is known in the art. The data inputs can be used to provide histories of a particular operating condition that can be numerical in value or observable, like dirty floor. This information can be used for comparison purposes. On observable (sensory or qualitative) criteria, standards can be established and inspectors trained to use a numerical scale (structured scale) or the like, like hedonic or other sensory evaluation of acceptable food and food wastes, so that inspector subjectivity can be reduced by recording input data quantitatively thereby providing data that can be analyzed and compared with greater reliability.

When working across company lines, industry lines and even intracompany, there may be restrictions on what may be shared with others. The system 200 and/or its components can be programmed with hierarchical, selective access structure for the handling and dissemination of the information and notices. While much information might be freely shared and designated as such, some companies or industries might want to designate some information or data as proprietary and not to be shared, or proprietary but usable in building blind (non source specified) industry databases for analysis that can be shared. Thus, the knowledge achievable with the system described herein, can be increased while still providing security. This is important since many issues are intercompany and interindustry important. By way of example, if evidence or suspicion of a tainted ingredient like lettuce is discovered, all people handling lettuce, which can be input as information into the system 200, can be disseminated to all inspectors to check for the suspected ingredient. A problem that might be unique to one facility may cast a bad light on other similar facilities which can be avoided with the present invention.

A history of a facility or company can be used for scheduling of that facility or company. As an example, analysis of a history might indicate that only 6 pies on one day of the week are sold by a restaurant leaving six as waste while on other days, 12 are sold. While the operating manual may say prepare 12 per day, the system 200, can indicate to an inspector through a device 202 that the Wednesday production needs to be reduced at one or more restaurants, and can change the operating instruction for the impacted facilities.

Sourcing of materials can also be addressed with the system 200. Safe sources may be designated and sources may be indicated as suspect. Lot identification of materials may be similarly designated. Pricing of materials, or test results indicating economic adulteration by ingredient substitution, can be an input (and would likely be proprietary intercompany, interindustry). Pricing though can then be analyzed across a company and multiple facilities. This could be important in franchise situations to help improve margins. An inspector can provide this input during a facility visit and can respond to queries from the system 200. Pricing trends could also be analyzed and made into histories and turned into knowledge for use and dissemination.

Government regulations can also be an input. Examples of such can include cooking temperature, holding temperature, approved ingredients, standards of identity, labeling for allergens, etc.; all of which if not met can result in waste. These can then be compared to input data to determine compliance and with company specifications or standards. Company standards can also be an input as discussed above and similarly used. The two can be compared in the event human intervention is needed for a judgment on compliance. The use of such information, the data input and the histories built with the same might prompt a change in company specification and/or government regulations.

In a food plant or facility, the following types of items can be inspected for and better accommodated with the history and the created knowledge. Those items include quantity produced, time of production, external conditions like a road closure or convention in town, suppliers, ingredient lot numbers, expiration dates, pH, chlorine levels, ORP of wash and flume waters, temperature reading of material in storage, critical control points such as time and temperature for pasteurization, metal detector operation, proper use and storage of cleaning supplies, sanitation schedules, cutting and discard protocols, final product lot or batch coding and the environmental conditions for final product storage, etc. The device 202 can be provided with the ability to connect to sensors such as a bar code reader, RFID sensor input, temperature probes, pH meter, sound meter, photos, audio recording and the like. This direct reading of data can serve to eliminate human error in recording values, and thus greatly improve the quality of the data. The present invention can also be used to better determine appropriate lot sizes which is important in managing waste, market withdrawals and recalls.

The system 200 and its components are constructed and programmed to receive and provide real time information to appropriate personnel, query response, access to decision makers and the like and provides instantaneous communication that is bidirectional in real time. The system 200 can provide output on production scheduling, personnel needs, supply scheduling, remediation and corrective actions to be taken. It can be used to require that an inspector personally use another communication method, for example, a phone call or text message to address issues depending on desired security. It translates data and information input into usable knowledge that an uninformed as well as an informed person can use and can be used to enhance the performance of the inspector and the facility. Feedback to the inspector can be tailored for a particular facility or a group of facilities, say when local regulations are more stringent. Decision making is available through standard responses or judgment response.

The structure of the system 200 is such that it can verify that an inspection is being conducted and improve the chances that it is being conducted properly. The sign in/sign out procedure helps ensure that an inspection actually took place. Photos may be required or requested by the system and the device can be constructed to provide date stamped photos. Such photos can be examined by an expert or a more knowledgeable person with access to the system 200 to determine action/inaction. The programming can be provided that once data or information is input, it cannot be changed to enhance the trustworthiness of the input and analysis. The programming can allow an inspector the ability to change an input, and in the event of an input error could request an explanation of a change before the change can be made. The explanation would also be stored and a changed input would be highlighted as having been changed. The system is thus structured to a trust but verify architecture. Access to third parties and their experience and knowledge can be provided through the system 200 which can also, through programmed selection criteria, select a better qualified individual.

While the preferred embodiments disclosed hereinabove are directed toward the operation of a restaurant or food preparation plant, the disclosed invention could also be employed in the manufacture of drugs or pharmaceuticals.

Although the present invention has been described with reference to preferred embodiments, workers skilled in the art will recognize that changes may be made in form and detail without departing from the spirit and scope of the invention.

As demonstrated by the foregoing discussion, various embodiments may provide certain advantages, particularly in the context of monitoring and managing waste of food products in a food service environment. For instance, by using the portable device and web-based tools described in this disclosure, a user can monitor quantities and costs of food products that are wasted based on a number of metrics, e.g., over various periods of time, for individual or aggregated categories of food products, and at various locations. These costs can be tracked in real time and over periods of time relative to goals set for food waste costs.

It will be understood by those who practice the embodiments described herein and those skilled in the art that various modifications and improvements may be made without departing from the spirit and scope of the disclosed embodiments. The scope of protection afforded is to be determined solely by the claims and by the breadth of interpretation allowed by law.

I (we) claim:

1. A method of monitoring waste in a food or drug handling facility, the method including:
providing an inspector with a first device operable to communicate with a remote computer;
providing said first device with first information communicable to said inspector in at least one of visual and audio form, said first information including items to be inspected by said inspector;
said inspector conducting an inspection at least in part pursuant to said first information;
inputting second information representing results of said inspection into said first device and transmitting at least some of said second information to said remote computer to record a history of at least part of said inspection and identifying said input second information at least by date;
analyzing said input second information and building a knowledge database usable to evaluate said inspection results and identifying waste; and
sending at least one of information and inspection instructions to said first device for communication to said inspector if additional inspection work is desirable.

2. The method of claim 1 including inputting into said first device a facility identifier for a facility to be inspected and identifying said second information also by said facility identifier.

3. The method of claim 1 including analyzing at least a portion of said history of at least part of said inspection and entering at least a portion of said analysis of said input second information into said knowledge database.

4. The method of claim 1 including inputting cost data into at least one of said first device and said remote computer.

5. The method of claim 4 including inputting waste data into at least one of said first device and said remote computer and combining said waste data with said cost data and calculating waste cost data.

6. The method of claim 1 wherein at least one of said first device and said remote computer having information regarding government regulations and operating specification information and including comparing at least some of said second information to at least one of the government regulations and said operating specifications and determining if a potential waste causing safety issue is present.

7. The method of claim 5 including issuing a notice on said first device when a potential safety issue has been identified.

8. The method of claim 7 including an importance level with said notice.

9. The method of claim 1 wherein said second information includes information regarding completed waste and raw waste.

10. The method of claim 1 inputting additional said second information regarding a plurality of facilities and compiling said additional second information from the inspected facilities with said remote computer.

11. The method of claim 10 wherein said plurality of facilities including intracompany facilities.

12. The method of claim 11 wherein said plurality of facilities including intercompany facilities.

13. The method of claim 1 including analyzing at least some of said second information statistically and using the results of the analysis to generate at least some of said first information.

14. The method of claim 1 wherein said facility handles at least one of food and drugs.

15. The method of claim 1 including securing at least some of said second information against unauthorized changing.

16. The method of claim 1 wherein at least some of said first information being provided by human intervention based on analysis of at least some of said second information.

17. The method of claim 1 including inputting third information into at least one of the first device and the remote computer regarding outgoing inventory and incoming inventory and reconciling at least portions of said third information with at least portions of the second information.

18. The method of claim 1 including building a waste history with said second information in at least one of the first device and the computer.

19. A method of monitoring waste in a food or drug handling facility, said method including:
providing an inspector with a first electronic device operable to communicate with a remote computer;
providing said first device with first information communicable to said inspector in at least one of video and audio formats, said first information including items to be reviewed by said inspector;
said inspector conducting an inspection pursuant to instructions comprising at least a portion of said first information;
inputting second information into said first electronic device representing results of said inspection and constructing a waste history of at least part of said inspection in at least one of said first device and said remote computer and identifying said input second information by date and facility identifier;
inputting third information into at least one of said first electronic device and said remote computer, said third information including at least one of product processing specifications relating to a facility to be inspected, specifications relating to products handled in the facility, government regulations or laws applicable to the facility and products and processes for handling said products; and
analyzing said input second information by at least one of the first electronic device and the computer and building a knowledge database usable to evaluate the inspection results.

20. The method of claim 19 including transmitting at least a portion of said second information to the computer for at least temporary storage.

21. The method of claim 20 including building a history with at least some of said second information.

22. The method of claim 20 wherein said knowledge database is built using at least some of said second and said third information and said knowledge being used to at least one of create and verify said first information.

23. The method of claim 22 including modifying said first information in response to information in the knowledge database.

24. The method of claim 23 including analyzing at least some of said second information statistically and creating at least some of the knowledge therewith.

25. The method of claim 24 including using results of said statistical analysis to evaluate process control for at least one process at a facility.

26. The method of claim 20 including coordinating said second and said third information and creating at least some of said first information based on said coordination.

27. The method of claim 20 including at least one of changing and adding said first information for communication to said first electronic device.

28. The method of claim 20 including sending at least one additional instruction to said first electronic device in response to receipt by said remote computer of said second information for said inspector to review and act on.

29. The method of claim 20 including sending a notice to said first electronic device for said inspector to act on in response to information received by said remote computer.

30. The method of claim 29 wherein said notice includes a priority act instruction.

31. The method of claim 30 including requesting confirmation from said inspector that said notice has been received.

32. The method of claim 20 including securing at least some of said input second information against change without authorization.

33. The method of claim 32 wherein said second information includes identification of a facility to be inspected and inspector identification.

34. The method of claim 20 wherein said third information includes information from an expert.

35. The method of claim 20 including inputting a query into said first electronic device and transmitting said query to said remote computer, said remote computer reviewing the query for response.

36. The method of claim 35 including responding to said query from at least one of said knowledge database and said third information.

37. The method of claim 35 including forwarding said query to a person authorized to answer the query.

38. The method of claim 37 wherein said authorized person including at least one of a company employee and an expert.

39. The method of claim 35 wherein said query relates to at least one of an out of specification condition and an out of government regulation condition.

40. A waste monitoring system comprising:
a portable device to monitor product waste, said portable device comprising:
a processor;
a memory in communication with said processor, said memory storing processor-executable instructions that, when executed by said processor, cause said processor to control operation of said portable device to generate a graphical user interface (GUI), said GUI comprising a plurality of user-selectable elements accessible by a user operable to collect quantity data relating to respective quantities of a plurality of types of wasted products and operable to calculate cost data as a function of the quantity data;
a display device in communication with said portable device and configured to display said GUI;
a server in communication with said portable device and configured to receive the quantity data and the cost data from said portable device; and
a computing device in communication with said server and configured to receive said quantity data and said cost data from said server and to display at least one of said quantity data and said cost data.

41. A portable device for monitoring product waste, said portable device comprising:
a processor;
a memory in communication with said processor and string processor-executable instructions that, when executed by said processor, cause said processor to control operation of said portable device to generate a graphical user interface (GUI), said GUI comprising a plurality of user-selectable elements accessible by a user operable to collect quantity data relating to respective quantities of a plurality of types of wasted products and operable to calculate cost data as a function of the quantity data and transmit said quantity data and said cost data to a server; and
a display device in communication with said processor and configured to display said GUI.

42. An electronic device for monitoring waste, said electronic device comprising:
a processor;
a display device operably connected to the processor for display of waste evaluation instructions and waste input data;
program instructions operable to effect display of waste evaluation instructions and at least some of the input waste data;
a memory in communication with said processor and said display and operable to string processor-executable instructions that, when executed by said processor, cause said processor to control operation of said portable device to generate a graphical user interface (GUI) to collect quantity data relating to respective quantities of a plurality of types of wasted products, said
GUI comprising a plurality of user-selectable elements accessible by a user; and
means to effect communication between said electronic device and at least one of a computer and a server.

43. The electronic device of claim 42 including program instructions operable to calculate waste cost as a function of waste quantity data and waste cost data.

44. The electronic device of claim 42 wherein the display device is configured to display said GUI.

45. The electronic device of claim 42 wherein said wasted product is food.

46. The electronic device of claim 42 wherein said wasted product is a drug.
